(19) United States
(12) Patent Application Publication
(10) Pub. No.: US 2026/0102835 A1
(43) Pub. Date: Apr. 16, 2026

(54) STUD WELDING ARRANGEMENT, A PROCESS OF STUD WELDING, AND A CONSTRUCTION FROM STUD WELDING

(71) Applicant: Advanced Construction Robotics, Inc., Allison Park, PA (US)

(72) Inventors: Matthew Q. SHAFFER, Zelienople, PA (US); Stephen M. Muck, Butler, PA (US); Christopher L. Dixon, Tarentum, PA (US); Patrick A. Weber, Wexford, PA (US); Ricky A. Houghton, Wexford, PA (US)

(21) Appl. No.: 19/354,452

(22) Filed: Oct. 9, 2025

Related U.S. Application Data
(60) Provisional application No. 63/706,827, filed on Oct. 14, 2024.

(51) Int. Cl. B23K 9/20; B23K 37/02

(52) U.S. Cl. CPC B23K 9/20; B23K 37/02

(57) ABSTRACT

Stud welding arrangements, processes of stud welding, and constructions from stud welding are disclosed. According to the disclosure, the stud welding arrangement includes a mobile stud welder for welding studs to a welding surface, the mobile stud welder able to move vertically and horizontally relative to a portion of the welding surface, and one or more external supports supported separately from the welding surface. A construction includes the welding surface with the studs welded to the welding surface from the stud welding arrangement and a process uses the stud welding arrangement.

### CROSS-REFERENCE TO RELATED APPLICATIONS

The present application is a non-provisional patent application, claiming priority and benefit of U.S. Provisional Ser. No. 63/706,827, filed Oct. 14, 2024 and entitled “Stud Welding Arrangement, A Process of Stud Welding, and A Construction from Stud Welding” the entirety of which is incorporated by reference.

### FIELD OF THE INVENTION

The present invention is directed to stud welding. More particularly, the present invention is directed to a stud welding arrangement, a process of stud welding, and a construction from stud welding.

### BACKGROUND OF THE INVENTION

Stud welding is an important aspect of construction, especially for large structures. For stud welding, a weld stud is welded to a base metal material, for example, through capacitor discharge stud welding, drawn arc stud welding, friction welding, or other suitable welding techniques. American Welding Society D1.1/1.1M: 2015, Structural Welding Code for Steel, and ASTM A706/A706M define preferred practices relating to stud welding, including compositional considerations and equipment requirements.

Some manufacturing uses automated or semi-automated stud welding. For example, U.S. Pat. No. 5,130,510, entitled “Automated shear stud welding system,” enables stud welding in a production facility setting for a welding surface of limited size and complexity. The system has limitations regarding vertical movement, horizontal movement, and is supported by the same structure as the weld surface, thereby not being useful in the field. In general, such concepts are more applicable to in-line production with smaller parts able to move along a conveyer.

Robotic welding in the field has been conceived, for example, through U.S. Pat. No. 7,641,461, entitled “Robotic systems for automated construction.” Such concepts have significant mobility limitations due to being connected to a robotic arm in a fixed location. In addition, such concepts do not encompass stud welding, which has unique challenges to overcome due to use of a weld stud.

Stud welding of large structures or outside is performed manually through use of a stud gun. When using the stud gun on a large structure, significant heat is produced along the path of the power cord. To address the heat, it is common to see buckets of water on a large structure for cooling of the power cord. Such operations are not desirable.

Stud welding arrangements, processes of stud welding, and constructions from stud welding that do not suffer from such drawbacks would be desirable in the art.

### BRIEF DESCRIPTION OF THE INVENTION

In an embodiment, a stud welding arrangement includes a mobile stud welder for welding studs to a welding surface, the mobile stud welder able to move vertically and horizontally relative to a portion of the welding surface, and one or more external supports supported separately from the welding surface.

In another embodiment, a process of stud welding includes welding a weld stud to a welding surface using a stud welding arrangement that includes a mobile stud welder for welding studs to a welding surface, the mobile stud welder able to move vertically and horizontally relative to a portion of the welding surface, and one or more external supports supported separately from the welding surface.

In another embodiment, a construction form includes a welding surface with studs welded to the welding surface from a stud welding arrangement that includes a mobile stud welder for welding the studs to the welding surface, the mobile stud welder able to move vertically and horizontally relative to a portion of the welding surface, and one or more external supports supported separately from the welding surface.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 shows a schematic view of an embodiment of a stud welding arrangement during an embodiment of a process of stud welding to produce an embodiment of a construction from stud welding, according to the disclosure.

FIG. 2 shows a schematic view of an interior of a mobile stud welder with loaded welding studs, according to an embodiment of the disclosure.

Wherever possible, the same reference numbers will be used throughout the drawings to represent the same parts.

### DETAILED DESCRIPTION OF THE INVENTION

Provided are stud welding arrangements, processes of stud welding, and constructions from stud welding. Embodiments of the present disclosure, for example, in comparison to concepts failing to include one or more of the features disclosed herein, improves upon prior art (such as, U.S. Pat. No. 5,130,510, entitled “Automated shear stud welding system,” and U.S. Pat. No. 7,641,461, entitled “Robotic systems for automated construction,” which are each hereby incorporated by reference in their entirety), permit stud welding on large structures, permit stud welding on complex geometry structures (for example, non-planar, curved, angled), permit stud welding through a variety of techniques (for example, capacitor discharge stud welding, drawn arc stud welding, friction welding, or other suitable welding techniques), permit stud welding at multiple job sites, permit stud welding outside, permit stud welding of constructions incapable of or unsafe for supporting the stud welder, permit improved safety (for example, by reducing risk from power cord heat and/or by reducing need for individual welders to be in precarious conditions), permit improvements compared to current standards (such as, American Welding Society D1.1/1.1M: 2015, Structural Welding Code for Steel, and ASTM A706/A706M, both of which are incorporated by reference), or a combination thereof.

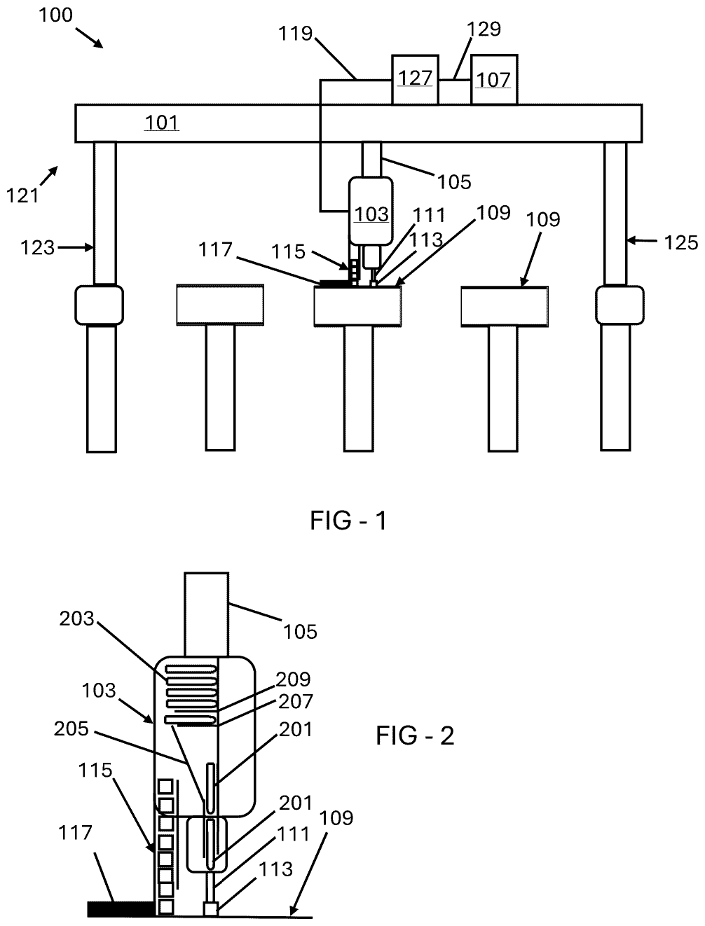

Referring to FIG. 1, in one embodiment, a stud welding arrangement 100 includes an elevated support 101, a mobile stud welder 103 (or a plurality operated simultaneously and synchronistic, simultaneously and asynchronistic, sequentially, or under a sequence defined by any suitable algorithm) supported by the elevated support 101 and a stability element 105, allowing welding to secure a weld stud 111 to a welding surface 109, for example, consistent with a predetermined specification. The welding surface 109 is geometrically complex, geometrically simple (such as, square, planar, or round), planar, non-planar, varied, consistent, angled, or any suitable combination thereof. Examples of the welding surface 109 include a beam, a deck pan/tin (of a bridge construction), sheet metal (for example, corrugated steel), a hull/deck of a boat/ship construction, a girder, any other suitable structure, fuselage, a wing, an airfoil, or a combination thereof.

In one embodiment, the elevated support 101 is a portion of a gantry system 121. The gantry system 121 is a structure such as those described in U.S. Pat. No. 10,061,323, entitled “Autonomous apparatus and system for repetitive tasks in construction project” and U.S. Pat. No. 10,597,264, entitled “Semi-autonomous system for carrying and placing elongate objects,” which are each incorporated by reference in their entirety. The gantry system 121 is capable of adjusting the position of the mobile stud welder 103 relative to the welding surface 109 in a vertical direction, a horizontal direction, forwards/backwards, in pitch, in yaw, or a combination thereof.

The mobile nature of the mobile stud welder 103 contrasts robotic arms from single locations and contrasts elevated work platforms which move along the ground, along a substrate, above a substrate, and/or perpendicular to gravity. The mobile stud welder 103 (and/or the stud weld arrangement 100 overall) are capable of being positioned on one or more trailers or transport containers, allowing the mobile stud welder 103 to be used in multiple locations/sites having varied topography.

In one embodiment, the gantry system 121 includes a first vertical support 123 and a second vertical support 125 as external supports, the mobile stud welder 103 being movably positioned between the first vertical support 123 and the second vertical support 125. In further embodiments, additional supports are used. The first vertical support 123 and the second vertical support 125 extend from a position and/or structure separate from the welding surface 109, such as, a screed rail of a bridge construction, an edgeform of a bridge construction, a clip, a foundation, a separate bridge, a separate rail, a pipe, ground, water, or combinations thereof.

Suitable embodiments include the welding surface 109 being or being a portion of a bridge construction, a building construction, a ship construction, a plane construction, a vehicle construction (for example, a truck, a car, or a tank), a submarine construction, metal fabrication, manufacturing, or a combination thereof.

Through a stud welding process according to an embodiment of the disclosure, a plurality of studs welded to the weld surface 109 are positioned on a construction produced by the stud welding process. The studs are with a predetermined position and orientation.

According to one embodiment, portions relating to the placement include aspects disclosed in U.S. Patent Application Publication No. 2017/0291242, entitled “Systems and methods for automated stud placement and welding,” the entirety of which is incorporated by reference. In a further embodiment, based upon the mobility of the mobile stud welder 103 the studs are positioned at a greater consistency and/or in more complex arrangements.

In one embodiment, the stud welding arrangement 100 includes a stud localization system capable of identifying one more of the weld studs 111 secured to the weld surface 109. For example, in a further embodiment, the stud localization system captures the position and/or orientation of the weld stud(s) 111 on the weld surface 109, saving the corresponding data to build a map of the data. The identification is carried out using image-based techniques, thermal techniques, light measurements (for example, a luxmeter or gloss-meter), other suitable passive techniques, or a combination thereof. Additionally or alternatively, the identification is carried out using active techniques, for example, tagging or marking the stud(s), for example, with paint, chalk, numbers/letters/symbols, colors, tape/stickers, other additions or modifications to the weld stud(s) 111 or regions proximal to the weld stud(s) 111, or a combination thereof.

According to one embodiment, the mobile stud welder 103 includes features disclosed in U.S. Patent Application Publication No. 2020/0316706, entitled “Welding nozzle assembly and method of use thereof,” the entirety of which is incorporated by reference. Specific embodiments include the features for positioning the weld stud 111 and a ferrule 113.

In a further or alternative embodiment, referring to FIG. 2, the mobile stud welder 103 includes stored studs 203, secured by a lower mechanism 207 and an upper mechanism 209 to position the studs ahead of the studs sliding along a funnel path 205 allowing the studs to be positioned as loaded studs 201, for example, linearly arranged and inserted for the stud welding. In other embodiments, other suitable mechanisms for managing the studs are used, such as, a cartridge assembly, a chain assembly (like in a machine gun chain), a disorganized box with vibrations or mechanical stirring to load the stored studs 203, compressed air manipulation of the stored studs 203, or any other mechanical or computerized system.

In one embodiment, the ferrule 113 is positioned from a ferrule containment area 115 using the same mechanism as the stored studs 203 or a different mechanism. For example, as shown in FIG. 2, in one embodiment, the ferrule containment area 115 includes the ferrules 113 being stacked and removed through an urging mechanism 117, allowing the ferrule 113 to be positioned at a predetermined location on the weld surface 109, ready for the weld stud 111 to be welded. In a further embodiment, one or more of the ferrules 113 include securing properties, such as, adhesive properties, allowing the ferrule to be temporarily secured with the weld stud 111 being welded immediately thereafter or substantially later (for example, minutes, hours, or even days later).

Referring again to FIG. 1, in one embodiment, the elevated support 101 supports a power system 127 (for example, a battery-containing welding operation unit) and, optionally, a power source 107 (for example, a generator) connected to the power system 127 by a power cord 129. Alternatively, the power source 107 is connected to the power system 127 but not supported by the elevated support 101. The power system 127 is connected to the mobile stud welder 103 by a stud weld cord 119. The stud weld cord 119 is able to be shorter than the length and/or width of a region to be stud welded, for example, due to the mobility of the mobile stud welder 103. In further embodiments, the configuration limits unsafe heat along the stud weld cord 119, reduces current and/or voltage challenges along the stud weld cord 119, and/or limits the ability for individuals to trip over the stud weld cord 119.

In one embodiment, the stud weld cord 119, on externally exposed surfaces, generates less heat than 50 degrees Celsius, less than 100 degrees Celsius, between 20 degrees and 100 degrees Celsius, between 20 degrees and 80 degrees Celsius, between 20 degrees and 60 degrees Celsius, between 20 degrees and 40 degrees Celsius, between 20 degrees and 30 degrees Celsius, or any suitable combination, sub-combination, range, or sub-range therein.

Additionally or alternatively, in one embodiment, the stud weld cord 119 is inaccessible at any portion generating heat on such surfaces that is greater than 30 degrees Celsius, greater than 40 degrees Celsius, greater than 70 degrees Celsius, greater than 100 degrees Celsius, or any suitable combination, sub-combination, range, or sub-range therein.

The stability element 105 is or includes any features for maintaining a position range and orientation range to allow the weld stud(s) 111 to be welded onto the weld surface 109 within a predetermined area. In one embodiment, the stability element 105 suspends from the elevated support 101 and provides the stability by having a mass sufficient to prevent unintended movement in response to forces such as wind, the stud welding (such as, a recoil effect), or other movement on the construction. The mass is any amount sufficiently capable of being supported by the stud welding arrangement 100, for example, between 10 kg and 100 kg, 10 kg and 300 kg, 10 kg and 500 kg, 10 kg and 1,000 kg, 10 kg and 2,000 kg, 100 kg and 300 kg, 100 kg and 500 kg, 100 kg and 1,000 kg, 100 kg and 2,000 kg, 300 kg and 500 kg, 300 kg and 1,000 kg, 300 kg and 2,000 kg, 500 kg and 1,000 kg, 500 kg and 2,000 kg, 1,000 kg and 2,000 kg, or any suitable combination, sub-combination, range, or sub-range therein.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A stud welding arrangement, comprising:
a mobile stud welder for welding studs to a welding surface, the mobile stud welder able to move vertically and horizontally relative to a portion of the welding surface; and
one or more external supports supported separately from the welding surface.

2. The stud welding arrangement of claim 1, further comprising the welding studs welded to the welding surface.

3. The stud welding arrangement of claim 1, wherein the mobile stud welder comprises a loaded welding stud positioned within the mobile stud welder.

4. The stud welding arrangement of claim 1, wherein the mobile stud welder comprises a plurality of loaded welding studs positioned within the mobile stud welder.

5. The stud welding arrangement of claim 1, wherein the mobile stud welder comprises stored weld studs positioned within the mobile stud welder.

6. The stud welding arrangement of claim 1, wherein the mobile stud welder includes a cartridge assembly having weld studs.

7. The stud welding arrangement of claim 1, wherein the mobile stud welder includes a chain assembly having weld studs.

8. The stud welding arrangement of claim 1, wherein the mobile stud welder comprises ferrules positioned within the mobile stud welder.

9. The stud welding arrangement of claim 1, wherein the mobile stud welder comprises ferrules stacked within the mobile stud welder.

10. The stud welding arrangement of claim 1, wherein the welding surface is a portion of a bridge construction.

11. The stud welding arrangement of claim 1, wherein the welding surface is a portion of a building construction.

12. The stud welding arrangement of claim 1, wherein the welding surface is a portion of a ship construction, a plane construction, a vehicle construction, a submarine construction.

13. A construction comprising the welding surface with the studs welded to the welding surface from the stud welding arrangement of claim 1.

14. A process of using the stud welding arrangement of claim 1.

15. The stud welding arrangement of claim 1, comprising a power system supported by the elevated support.

16. The stud welding arrangement of claim 1, comprising a power source supported by the elevated support.

17. The stud welding arrangement of claim 1, comprising a stud weld cord, the stud weld cord being shorter than a length and width of a region to be stud welded.

18. The stud welding arrangement of claim 1, wherein the stud weld cord generates less than 50 degrees Celsius of heat.

19. The stud welding arrangement of claim 1, wherein the stud weld cord is inaccessible at any portion generating greater than 30 degrees Celsius of heat.

20. The stud welding arrangement of claim 1, comprising a stability element supported by the elevated support.
